(19) United States
(12) Patent Application Publication
(10) Pub. No.: US 2005/0096421 A1
(43) Pub. Date: May 5, 2005

(54) Aqueous metallic paint for automobile interior materials and coated article

(75) Inventors: Takashi Watanabe, Hirakata-shi (JP); Isao Furutsuka, Hirakata-shi (JP); Ikuo Asato, Hirakata-shi (JP)

Correspondence Address: ROBERT J JACOBSON PA, 650 BRIMHALL STREET SOUTH, ST PAUL, MN, 551161511, US

(73) Assignee: Nippon Bee Chemical Co., Ltd.

(21) Appl. No.: 10/966,392

(22) Filed: Oct. 14, 2004

(30) Foreign Application Priority Data
Oct. 29, 2003 (JP) 2003-369587

(51) Int. Cl. C08K 3/08

(52) U.S. Cl. 524/439

(57) ABSTRACT

An object of the present invention is to provide: an aqueous metallic paint for automobile interior materials wherein the coating film formed from this paint is not clouded by the aqueous alkali solution; and a coated article with this paint. As a means of achieving this object, an aqueous metallic paint for automobile interior materials, according to the present invention, is a paint comprising a vehicle and a metallic pigment, with the paint being characterized in that the vehicle is an aqueous hydrosol resin formed by hydrosolation of an aqueous acrylic resin having an acid value of 15 to 40 mgKOH/g. In addition, a coated article according to the present invention is coated with the aforementioned aqueous metallic paint according to the present invention for automobile interior materials.

### BACKGROUND OF THE INVENTION

A. Technical Field

The present invention relates to: an aqueous paint for automobile interior materials of a metallic color; and a coated article with this paint.

B. Background Art

Used for automobile interior are various plastic materials selected according to physical properties demanded to product specifications. These plastic materials are coated appropriately for interior materials. As a coating color of these automobile interior materials, in recent years, a metallic color high in design property is rapidly rising in popularity. Therefore increasing is a demand for paints for automobile interior materials of metallic colors.

By the way, in recent years, while a demand for discharge diminishment of organic solvents is increasing from the viewpoint of the environmental protection, various paints are also required to be converted from conventional organic solvent type paints into aqueous paints. Thus, as an aqueous paint for automobile interior materials, there is proposed an aqueous paint composition including a resin emulsion as an essential component wherein the resin emulsion is obtained by mixing a chlorinated polyolefin resin emulsion and a pure acrylic resin emulsion in a specific ratio (refer to patent document 1 below).

[Patent Document 1] JP-A-002977/2001 (Kokai)

However, in prior aqueous paints such as described in patent document 1 above, usually, there is used, as a vehicle in order to keep the stability in water, the following: an emulsion resin using a surfactant which is a hydrophilic substance; or a water-soluble resin of a relatively low molecular weight having many hydrophilic functional groups. Therefore, coating films formed from such paints have a demerit of being so low in alkali resistance as to tend to become impregnated with an aqueous alkali solution under conditions where exposed to this aqueous alkali solution. Therefore, as to such prior aqueous paints, for example, in the case where they are mixed with metallic pigments (e.g. aluminum flakes) to thus produce metallic colors, there may occur a problem that, if the formed coating films are exposed to the aqueous alkali solution, then the metallic pigments in the coating films are dissolved by the aqueous alkali solution to thus cloud unfavorably.

After having been made into products for automobiles and sold, the automobile interior materials are sometimes wiped with alkaline detergents (e.g. soap liquids, window washer liquids). Therefore, the paint for automobile interior materials is particularly required not to involve the aforementioned problem that the metallic pigment is dissolved by the aqueous alkali solution to thus cloud. Therefore, for the aqueous paint for automobile interior materials to be a metallic color, the coating film formed from this paint needs not to be clouded by the aqueous alkali solution. However, none of the prior aqueous paints for automobile interior materials has sufficient alkali resistance. Therefore, in the present state of arts, the aqueous metallic paint has not yet been put to practical use as such for automobile interior materials.

### SUMMARY OF THE INVENTION

### A. Object of the Invention

Thus, an object of the present invention is to provide: an aqueous metallic paint for automobile interior materials wherein the coating film formed from this paint is not clouded by the aqueous alkali solution; and a coated article with this aqueous metallic paint for automobile interior materials.

### B. Disclosure of the Invention

The present inventors diligently studied to solve the above problems. As a result, they have found out that, if an aqueous hydrosol resin formed by hydrosolation of an aqueous acrylic resin having a specific range of acid value is used as a vehicle, then the resultant paint can form a coating film excellent in the alkali resistance, though being an aqueous paint. Then, the present inventors have completed the present invention by confirming that such a paint can solve the aforementioned problems at a stroke.

That is to say, an aqueous metallic paint for automobile interior materials, according to the present invention, is a paint comprising a vehicle and a metallic pigment, with the paint being characterized in that the vehicle is an aqueous hydrosol resin formed by hydrosolation of an aqueous acrylic resin having an acid value of 15 to 40 mgKOH/g.

A coated article according to the present invention is coated with the aforementioned aqueous metallic paint according to the present invention for automobile interior materials.

### C. Effects of the Invention

The aqueous metallic paint according to the present invention for automobile interior materials can avoid the clouding (caused by the aqueous alkali solution) of the coating film formed from this paint and can color the automobile interior materials a metallic color high in design property while meeting the demand for the environmental protection.

These and other objects and advantages of the present invention will be more fully apparent from the following detailed disclosure.

### DETAILED DESCRIPTION OF THE INVENTION

Hereinafter, detailed descriptions are given about the aqueous metallic paint according to the present invention for automobile interior materials and about the coated article according to the present invention. However, the scope of the present invention is not bound to these descriptions. And other than the following illustrations can also be carried out in the form of appropriate modifications of the following illustrations within the scope not departing from the spirit of the present invention.

The aqueous metallic paint according to the present invention contains the specific aqueous hydrosol resin as the vehicle. Hereinafter, detailed descriptions are given about this aqueous hydrosol resin.

The aqueous hydrosol resin in the present invention is formed by the hydrosolation of the aqueous acrylic resin. The aforementioned aqueous hydrosol resin can be obtained, for example, by a process including the steps of carrying out solution polymerization of a polymerizable monomer component to constitute the aqueous acrylic resin and then carrying out the hydrosolation of the resultant resin solution of the aqueous acrylic resin.

The aforementioned polymerizable monomer component to constitute the aqueous acrylic resin will do if it includes an α,β-ethylenically unsaturated monomer having an acid group on condition that such as (meth)acrylic acid and/or a (meth)acrylate is included as an essential component. Incidentally, though not especially limited, the ratio for which the (meth)acrylic acid and/or (meth)acrylate accounts in the aforementioned polymerizable monomer component is favorably not less than 80 mass % of the polymerizable monomer component.

Example of the aforementioned α,β-ethylenically unsaturated monomer having an acid group include (meth)acrylic acid, acrylic acid dimer, crotonic acid, 2-acryloyloxyethylphthalic acid, 2-acryloyloxyethylsuccinic acid, 2-acryloyloxyethyl acid phosphate, 2-acrylamido-2-methylpropanesulfonic acid, ω-carboxy-polycaprolactone mono(meth)acrylate, isocrotonic acid, α-hydro-ω-[(1-oxo-2-propenyl)oxy]poly[oxy(1-oxo-1,6-hexanediyl)], maleic acid, fumaric acid, itaconic acid, 3-vinylsalicylic acid, and 3-vinylacetylsalicylic acid. Among these, the acrylic acid and the methacrylic acid are particularly favorable. The α,β-ethylenically unsaturated monomers having an acid group may be used either alone respectively or in combinations with each other.

The ratio for which the aforementioned α,β-ethylenically unsaturated monomer having an acid group accounts in the polymerizable monomer component will do if it is set appropriately so that the acid value of the resultant aqueous acrylic resin will be in the range of 15 to 40 mgKOH/g as mentioned below.

The aforementioned polymerizable monomer component may include a monomer having a hydroxyl group besides the aforementioned α,β-ethylenically unsaturated monomer having an acid group. Examples of the monomer having a hydroxyl group include hydroxyethyl (meth)acrylate, hydroxypropyl (meth)acrylate, hydroxybutyl (meth)acrylate, allyl alcohol, methallyl alcohol, and addition products from hydroxyethyl (meth)acrylate and ε-caprolactone. The monomers having a hydroxyl group may be used either alone respectively or in combinations with each other.

In the case where the aforementioned polymerizable monomer component further includes the monomer having a hydroxyl group, the ratio for which the aforementioned monomer having a hydroxyl group accounts in the polymerizable monomer component is favorably set so that the hydroxyl group value of the resultant aqueous acrylic resin will not be more than 50 mgKOH/g, though not especially limited.

If necessary, the aforementioned polymerizable monomer component may further include another α,β-ethylenically unsaturated monomer besides the aforementioned α,β-ethylenically unsaturated monomer having an acid group. Examples of the above other α,β-ethylenically unsaturated monomer include: (meth)acrylate esters (e.g. methyl (meth)acrylate, ethyl (meth)acrylate, n-butyl (meth)acrylate, isobutyl (meth)acrylate, t-butyl (meth)acrylate, 2-ethylhexyl (meth)acrylate, lauryl methacrylate, phenyl acrylate, isobornyl (meth)acrylate, cyclohexyl methacrylate, t-butylcyclohexyl (meth)acrylate, dicyclopentadienyl (meth)acrylate, and dihydrodicyclopentadienyl (meth)acrylate); polymerizable amide compounds (e.g. (meth)acrylamide, N-methylol(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, and N-(2-hydroxyethyl)(meth)acrylamide); polymerizable aromatic compounds (e.g. styrene, α-methylstyrene, vinyl ketone, t-butylstyrene, p-chlorostyrene, and vinylnaphthalene); polymerizable nitriles (e.g. (meth)acrylonitrile); α-olefin (e.g. ethylene and propylene); vinyl esters (e.g. vinyl acetate and vinyl propionate); and dienes (e.g. butadiene and isoprene). The above other α,β-ethylenically unsaturated monomers may be used either alone respectively or in combinations with each other.

In the case where the polymerizable monomer component further includes the aforementioned other α,β-ethylenically unsaturated monomer, the ratio for which this other α,β-ethylenically unsaturated monomer accounts in the polymerizable monomer component is favorably set in the range of 92 to 98 mass % of the polymerizable monomer component, though not especially limited.

Though not especially limited, examples of polymerization initiators usable in the aforementioned solution polymerization to obtain the aqueous acrylic resin include: azo polymerization initiators (e.g. azobisisobutyronitrile); and peroxide polymerization initiators (e.g. benzoyl peroxide, p-chlorobenzoyl peroxide, lauroyl peroxide, and t-butyl perbenzoate). The polymerization initiators may be used either alone respectively or in combinations with each other. Incidentally, in the aforementioned polymerization, it is also possible that, when the occasion demands, chain transfer agents (e.g. mercaptans (e.g. laurylmercaptan) and α-methylstyrene dimer) are used for the purpose of adjusting the molecular weight.

In the aforementioned solution polymerization to obtain the aqueous acrylic resin, it is possible to use, as solvents, for example, the following: aromatic hydrocarbons (e.g. toluene and xylene); aliphatic hydrocarbons (e.g. hexane, heptane, and octane); esters (e.g. ethyl acetate, n-butyl acetate, isobutyl acetate and amyl acetate); ethers (e.g. propylene glycol monomethyl ether); ketones; alcohols or their derivatives; diethylene glycol or its derivatives; propylene glycol or its derivatives; and dioxane, N-methylpyrrolidone, and dimethylformamide. The solvents may be used either alone respectively or in combinations with each other.

Though not especially limited, the process for the aforementioned solution polymerization will do, for example, if it includes the following steps of: charging a reactor with the solvent; and then heating the solvent to a prescribed reaction temperature; and then dropping the polymerizable monomer component and the polymerization initiator into the reactor at the above temperature; and then carrying out the polymerization at a constant temperature for a prescribed time. In this process, the reaction temperature is favorably set in the range of 100 to 120° C., and the reaction time is favorably set in the range of about 5 to about 8 hours.

It is important that the acid value of the aforementioned aqueous acrylic resin is in the range of 15 to 40 mgKOH/g. Because the aqueous hydrosol resin formed by hydrosolation of the aqueous acrylic resin having such a specific acid value is used as the vehicle, the aqueous metallic paint according to the present invention can avoid the clouding (caused by the alkali) of the coating film formed from this paint. The acid value of the aforementioned aqueous acrylic resin is favorably in the range of 20 to 30 mgKOH/g. In the case where the acid value of the aqueous acrylic resin is less than 15 mgKOH/g, it is impossible to obtain the aqueous hydrosol resin actually as an aqueous one, thus resulting in failure to obtain the aqueous paint. On the other hand, in the case where the acid value of the aqueous acrylic resin. is more than 40 mgKOH/g, the alkali resistance of the resultant aqueous hydrosol resin is so insufficient that, if the metallic pigment is added, the formed coating film is clouded by the aqueous alkali solution.

Though not especially limited, the weight-average molecular weight of the aforementioned aqueous acrylic resin is, for example, favorably in the range of 15,000 to 100,000.

The process for the hydrosolation of the aforementioned aqueous acrylic resin can be carried out by hitherto publicly known processes without especial limitation. For example, it will do to adopt such as: 1) a process in which the resin solution of the aqueous acrylic resin, obtained by the aforementioned polymerization, is added into a receptacle containing a neutralizing agent and water to forcedly disperse the resin solution into water; 2) a process in which the neutralizing agent is added to the aforementioned resin solution to thus neutralize it, and then the resultant neutralized resin solution is dispersed into water while added into a water-containing receptacle under stirring; and 3) a process in which the neutralizing agent is added to the aforementioned resin solution to thus neutralize it, and then high-temperature water is gradually added to the resultant neutralized resin solution while this solution is a little heated under stirring, whereby the phase is reversed to thus disperse the resin solution into water. Incidentally, the ratio among the aforementioned resin solution, neutralizing agent, and water, which are used in the hydrosolation of the aforementioned aqueous acrylic resin, is favorably in the range of (amount of resin solution)/(total amount of neutralizing agent and water) (mass ratio)=(35 to 45)/(65 to 55).

The aforementioned neutralizing agent being used for the hydrosolation of the aforementioned aqueous acrylic resin is not especially limited. Usable examples thereof include organic amine compounds (e.g. primary amines, secondary amines, and tertiary amines) and ammonia water. Specific examples of the organic amine compounds include alkylamines (e.g. monoethylamine, diethylamine, triethylamine, and tributylamine) and alkanolamines (e.g. monoethanolamine, diethanolamine, dimethylethanolamine, and methylpropanolamine). The neutralizing agents may be used either alone respectively or in combinations with each other.

Though not especially limited, the resin solid component content of the aforementioned aqueous hydrosol resin is favorably in the range of 20 to 35 mass %.

The content for which the aforementioned aqueous hydrosol resin accounts in the aqueous metallic paint according to the present invention is favorably not lower than 70 mass % in terms of resin solid component content relative to the entire resin solid components in the paint. In the case where the aqueous hydrosol resin content is lower than 70 mass %, there is a possibility that the resultant alkali resistance may be insufficient.

The aqueous metallic paint according to the present invention contains the metallic pigment. Accordingly, this paint is a paint of a metallic color. Examples of the aforementioned metallic pigment include metal-made shining materials (which may be either non-colored ones or colored ones) such as metals or alloys (e.g. aluminum (coating aluminum), copper, zinc, nickel, tin, and aluminum oxide). The metallic pigments may be used either alone respectively or in combinations with each other. Incidentally, in order that the metal (e.g. aluminum), constituting the aforementioned metallic pigment, can be prevented from corroding due to oxidation to thus precipitate and aggregate or come to display no metal gloss when the coating film has been formed, it is permitted to beforehand take measures such as of carrying out chromate treatment or oxidation prevention treatment or separately adding an antioxidant to the paint. Hereupon, usable examples of the antioxidant include organophosphorus compounds (e.g. lauryl phosphate and high-molecular acryl phosphate), and its amount being used may be set appropriately within the range not damaging the effects of the present invention.

The content for which the aforementioned metallic pigment accounts in the aqueous metallic paint according to the present invention is favorably in the range of 1 to 20 mass % relative to the entire solid components (resin solid components and other solid components (e.g. pigments)) in the paint. In the case where the metallic pigment content is lower than 1 mass %, the metallic aesthetic appearance tends to be insufficient. On the other hand, in the case where the metallic pigment content is higher than 20 mass %, there is a possibility that the resultant alkali resistance may be insufficient. Thus, both cases are unfavorable.

The aqueous metallic paint according to the present invention, favorably, further contains a mica pigment along with the aforementioned metallic pigment. In this case, the paint is accordingly a paint of a mica color as well as the metallic color, so that it becomes possible for this paint to provide the automobile interior materials with a coating film which is more excellent in the design properties. The mica pigment is not especially limited. Examples of its commercially available products include “IRIODIN” produced by Merck. In the case where the aqueous metallic paint according to the present invention contains the mica pigment as well, its content is favorably in the range of 1 to 20 mass % relative to the entire solid components (resin solid components and other solid components (e.g. pigments)) in the paint.

If necessary, the aqueous metallic paint according to the present invention may further contain a pigment other than the aforementioned metallic pigment and mica pigment within the range not damaging the effects of the present invention. Examples of this pigment other than the aforementioned metallic pigment and mica pigment include: inorganic pigments (e.g. titanium oxide, carbon black, iron oxide pigments, chromium oxide); organic pigments (e.g. azo pigments, anthracene pigments, perylene pigments, quinacridone pigments, isoindolinone pigments, indigo pigments, phthalocyanine pigments); extenders (e.g. talc, precipitated barium sulfate, silicates); and conductive pigments (e.g. conductive carbon). The pigments other than the aforementioned metallic pigment and mica pigment may be used either alone respectively or in combinations with each other.

The aqueous metallic paint according to the present invention contains water as the main solvent. However, this paint may further contain an organic solvent as another solvent if its amount is not larger than 50 mass % relative to water. Examples of this organic solvent include those which are aforementioned as examples of solvents usable in the polymerization to obtain the aqueous acrylic resin. The organic solvents may be used either alone respectively or in combinations with each other.

If necessary, within the range not damaging the effects of the present invention, the aqueous metallic paint according to the present invention may further contain, for example, the following: other aqueous resins; and additives (e.g. thickeners, defoamers, pigment dispersants, surface conditioners, leveling agents, ultraviolet absorbing agents, antioxidants, antiseptics, antimolds, plasticizers, conductive materials, electromagnetic-wave-absorbent materials, odorous-substance-absorbing agents).

The aqueous metallic paint according to the present invention can be obtained by uniformly mixing the aforementioned components by conventional methods. For example, it will do to, under stirring, add the aforementioned components one by one or all at once into a container equipped with a stirrer, thus uniformly mixing them together. In addition, as to the pigment, it may be beforehand dispersed into a part or the whole of the vehicle to a necessary level to thus form a pigment paste and then added.

The aqueous metallic paint according to the present invention, favorably, has a pH of 7 to 9. If necessary, within the range not damaging the effects of the present invention, the aqueous metallic paint according to the present invention may be pH-adjusted with the aforementioned neutralizing agent which is used for the hydrosolation of the aforementioned aqueous acrylic resin.

The aqueous metallic paint according to the present invention may be coated either directly onto an object to be coated or onto a primer coating film (as an undercoat) having beforehand been formed on the object to be coated.

There is no especial limitation on the coating method when coating the aqueous metallic paint according to the present invention. It is possible to adopt publicly known methods such as air spray coating, rotary disk coating, dip coating, and brush coating. In addition, the coating deposition efficiency may be enhanced by applying the static electrification when the coating is carried out.

The coating amount, when coating the aqueous metallic paint according to the present invention, may be set appropriately for its uses and is therefore not especially limited. However, for example, in the case of using this paint for interior materials, it is recommended that the coating amount should be set so that the resultant dried film thickness will be in the range of 10 to 50 μm, favorably 15 to 40 μm. In the case where the dried film thickness is too thin, there is a possibility that the color of the object to be coated cannot completely be hidden, and further, it is difficult to obtain a smooth coating film. On the other hand, in the case where the dried film thickness is too thick, popping tends to occur in the drying step, or the orientation of the metallic pigment tends to get out of order to thus result in deterioration of the brilliant feeling.

After the aqueous metallic paint according to the present invention has been coated, the drying temperature of its coating film will do if it is set appropriately with consideration given to the heat resistance of the object to be coated. Therefore, it is not especially limited. However, for example, it may be set in the range of 40 to 140° C. In addition, in this step, the drying time may be set, for example, in the range of about 5 to about 60 minutes, though depending on the drying temperature.

The coated article according to the present invention is coated with the aforementioned aqueous metallic paint according to the present invention. That is to say, the coated article according to the present invention is an article which is provided at least with: a substrate as the object of the coating (object to be coated); and a coating film formed on the surface of the above substrate from the aqueous metallic paint according to the present invention in the aforementioned way.

The substrate as the object to be coated is not especially limited. However, various plastic materials are favorable. Examples thereof include polyolefins (e.g. polypropylene (PP) and polyethylene (PE)), and besides, acrylonitrile-styrene (AS), acrylonitrile-butadiene-styrene (ABS), poly(phenylene oxide) (PPO), poly(vinyl chloride) (PVC), polyurethane (PU) and polycarbonate (PC).

The coated article according to the present invention can favorably be used as an automobile interior material of a metallic color and, particularly, is favorably used, for example, as an automobile interior part (e.g. instrumental panel, center console, door trim). These are favorable to coat with the aqueous metallic paint according to the present invention. The resultant coated articles are excellent in such as appearance and general performance.

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to them. Hereinafter, unless otherwise noted, the units “mass part(s)” and “mass %” are referred to simply as “part(s)” and “%” respectively.

### PRODUCTION EXAMPLE 1

### Production of Aqueous Hydrosol Resin

An amount of 13.67 parts of propylene glycol monomethyl ether (PGME) and 13.57 parts of an aromatic hydrocarbon solvent (“Solveso 100” produced by Exxon Corporation) (these are referred to as component A) were charged into a reactor as equipped with a stirrer, a thermometer, a reflux condenser, dropping funnels, a nitrogen-introducing tube, and a heater with a thermostat. Then, the inner temperature was raised to 110° C. and the stirring was started. Next, a mixed solution (comprising 3.07 parts of methacrylic acid (MAA), 36.35 parts of methyl methacrylate (MMA), and 60.58 parts of n-butyl methacrylate (BMA)) (this is referred to as component B) and a polymerization initiator solution (comprising 2.2 parts of a peroxide polymerization initiator (“Kayaester 0” produced by Nippon Kayaku Co., Ltd.), 5 parts of propylene glycol monomethyl ether (PGME) and 5 parts of an aromatic hydrocarbon solvent (“Solveso 100” produced by Exxon Corporation)) (this is referred to as component C) were dropped over a period of 3 hours each to start the polymerization, while the inner temperature was kept at 110° C. Then, while the inner temperature of 110° C. was still kept after the end of the dropping, a solution (comprising 0.3 part of a peroxide polymerization initiator (“Kayaester 0” produced by Nippon Kayaku Co., Ltd.), 2.5 parts of propylene glycol monomethyl ether (PGME) and 2.5 parts of an aromatic hydrocarbon solvent (“Solveso 100” produced by Exxon Corporation)) (this is referred to as component D) was dropped over a period of 2 hours to end the polymerization, thus obtaining a resin solution of an aqueous acrylic resin. The acid value, having been determined by the KOH solution titration method, of this aqueous acrylic resin was as shown in Table 1.

Next, the inner temperature of the resin solution was dropped to 85° C., and then thereto 3.84 parts of dimethylethanolamine (DMEA) (this is referred to as component E) was added to neutralize carboxyl groups of the resin, and then further thereto 262.18 parts of deionized water of 85° C. (this is referred to as component F) was dropwise added over a period of 15 minutes, thereby reversing the polymer phase to form a hydrosol, thus obtaining an aqueous hydrosol resin (1).

The resin solid component content of the resultant aqueous hydrosol resin was determined in the following way. As a result, it was as shown in Table 1.

<Measurement of resin solid component content>:

An amount of (x) g of aqueous hydrosol resin was dried at 110° for 3 hours, and then the residual solid component amount (y) g was measured to make a calculation by the following equation.
Resin solid component content (%)=[(y)/(x)]×100

### PRODUCTION EXAMPLES 2 TO 6

### Production of Aqueous Hydrosol Resins

Aqueous hydrosol resins (2) to (5) were obtained in the same way as of Production Example 1 except that the amounts of the components A to F in Production Example 1 were changed as shown in Table 1. Incidentally, in Production Example 6, the hydrosolation was impossible. The acid value of the aqueous acrylic resin and the resin solid component content of the aqueous hydrosol resin in each Production Example are shown in Table 1.

Incidentally, in Table 1, the following abbreviations are used.
PGME: propylene glycol monomethyl ether
Solveso 100: aromatic hydrocarbon solvent (“Solveso 100” produced by Exxon Corporation)
MAA: methacrylic acid
MMA: methyl methacrylate
BMA: n-butyl methacrylate
Kayaester 0: peroxide polymerization initiator (“Kayaester 0” produced by Nippon Kayaku Co., Ltd.)

DMEA: dimethylethanolamine

TABLE 1

| | | Production | Production | Production | Production | Production | Production |
|---|---|---|---|---|---|---|---|
| | | Example 1 | Example 2 | Example 3 | Example 4 | Example 5 | Example 6 |
| Component A | PGME | 13.57 | 13.57 | 13.57 | 13.57 | 13.57 | 13.57 |
| | Solveso 100 | 13.57 | 13.57 | 13.57 | 13.57 | 13.57 | 13.57 |
| Component B | MAA | 3.07 | 4.6 | 6.14 | 2.3 | 7.67 | 1.54 |
| | MMA | 36.35 | 33.87 | 31.39 | 37.59 | 28.92 | 37.11 |
| | BMA | 60.58 | 61.52 | 62.42 | 60.11 | 63.41 | 61.35 |
| Component C | Kayaester O | 2.2 | 2.2 | 2.2 | 2.2 | 2.2 | 2.2 |
| | PGME | 5 | 5 | 5 | 5 | 5 | 5 |
| | Solveso 100 | 5 | 5 | 5 | 5 | 5 | 5 |
| Component D | Kayaester O | 0.3 | 0.3 | 0.3 | 0.3 | 0.3 | 0.3 |
| | PGME | 2.5 | 2.5 | 2.5 | 2.5 | 2.5 | 2.5 |
| | Solveso 100 | 2.5 | 2.5 | 2.5 | 2.5 | 2.5 | 2.5 |
| Component E | DMEA | 3.84 | 4.77 | 6.36 | 2.38 | 7.95 | 1.92 |
| Component F | Deionized | 262.18 | 262.18 | 262.18 | 262.18 | 262.18 | 262.18 |
| | water | | | | | | |

| | | | | | | |
|---|---|---|---|---|---|---|
| Acid value (mgKOH/g) | 20 | 30 | 40 | 15 | 50 | 10 |
| Resin solid component | 24.9 | 24.9 | 24.8 | 25 | 24.7 | — |
| content (%) | | | | | | |

### EXAMPLE 1

Under stirring, 120 parts of the aqueous hydrosol resin (1), 3 parts of a silicon additive (“Polyflow KL245” produced by KYOEISHA CHEMICAL Co., LTD.), 4.5 parts of N-methylpyrrolidone, and 4.78 parts of coating aluminum (“ALPASTE FZ0534” produced by TOYO ALUMINUM K.K.) were charged in that order into a reactor as equipped with a stirrer. After the charging of all the above materials had been completed, the stirring was continued for another 1 hour, thus obtaining an aqueous metallic paint.

The resultant aqueous metallic paint was air-spray-coated onto a commercially available acrylonitrile-butadiene-styrene (ABS) plate (70 mm×260 mm×3 mm) so that the resultant dried film thickness would be 20 μm, and then heat-dried at 80° C. for 30 minutes, thereby preparing a test piece to carry out the following evaluations. Their results are shown in Table 2.

<Adhesion>

In accordance with JIS-K5400 8.5.2, the coating film of the test piece was notched with a cutter to make 100 checkerboard squares of 2 mm×2 mm each. Thereafter, an adhesion-peeling test of sticking a pressure sensitive adhesive tape thereon and then forcedly peeling off the tape was carried out three times to make a judgment on the following standards:
◯: No peeling of the coating film is seen in all the three times of tests, X: peeling of at least one square is seen in the three times of tests.

<Alkali resistance>

A polyethylene-made cylinder of 40 mm in inner diameter and 15 mm in height was put on the coating film of the test piece, and then sealing between the cylinder and the coating film was made with an adhesive so that no liquid would leak from where the cylinder contacted with the coating film surface. Thereafter, 5 mL of a 0.1 N aqueous sodium hydroxide solution was placed into the cylinder, and then the top of the cylinder was covered with a watch glass to make an airtight state. Still in this state, they were left under an atmosphere of 55° C. for 4 hours. Thereafter, the aqueous sodium hydroxide solution in the cylinder was discharged, and then the cylinder was removed from the coating film, and then the coating film was washed with water and then air-dried. Then, the state of the portion, with which the aqueous sodium hydroxide solution had been brought into contact, of the coating film was observed with the eye to make a judgment on the following standards:

◯: There is no abnormality, Δ: a little aluminum discoloring is seen, but no clouding is seen, X:the aluminum is dissolved entirely, so clouding is seen.

### EXAMPLES 2 to 4 and COMPARATIVE EXAMPLE 1

Aqueous metallic paints were obtained in the same way as of Example 1 except that the aqueous hydrosol resin (1) used in Example 1 was replaced with each of the aqueous hydrosol resins (2) to (5) as shown in Table 2.

A test piece was prepared from each of the resultant aqueous metallic paints in the same way as of Example 1, and then the same evaluations as of Example 1 were carried out. Their results are shown in Table 2.

TABLE 2

| | | | | | Comparative |
|---|---|---|---|---|---|
| | Example 1 | Example 2 | Example 3 | Example 4 | Example 1 |
| Aqueous hydrosol | Aqueous hydrosol | Aqueous hydrosol | Aqueous hydrosol | Aqueous hydrosol | Aqueous hydrosol |
| resin used | resin (1) | resin (2) | resin (3) | resin (4) | resin (5) |
| Adhesion | ◯ | ◯ | ◯ | ◯ | ◯ |
| Alkali resistance | ◯ | ◯ | Δ | ◯ | X |

### Industrial Application

The aqueous metallic paint according to the present invention for automobile interior materials is usable favorably for obtaining the automobile interior materials of metallic colors.

Various details of the invention may be changed without departing from its spirit not its scope. Furthermore, the foregoing description of the preferred embodiments according to the present invention is provided for the purpose of illustration only, and not for the purpose of limiting the invention as defined by the appended claims and their equivalents.

1. An aqueous metallic paint for automobile interior materials, which is a paint comprising a vehicle and a metallic pigment, wherein the vehicle is an aqueous hydrosol resin formed by hydrosolation of an aqueous acrylic resin having an acid value of 15 to 40 mgKOH/g.

2. A coated article, which is coated with the aqueous metallic paint as recited in claim 1 for automobile interior materials.
